(19) United States
(12) Patent Application Publication
(10) Pub. No.: US 2014/0105549 A1
(43) Pub. Date: Apr. 17, 2014

(54) PLUG

(71) Applicant: MURATA MANUFACTURING CO., LTD., Kyoto (JP)

(72) Inventor: Katsumi KOHNISHI, Kyoto (JP)

(73) Assignee: MURATA MANUFACTURING CO., LTD., Kyoto (JP)

(21) Appl. No.: 14/141,264

(22) Filed: Dec. 26, 2013

Related U.S. Application Data
(63) Continuation of application No. PCT/JP2012/062364, filed on May 15, 2012.

(30) Foreign Application Priority Data
Jun. 27, 2011 (JP) 2011-141861

(51) Int. Cl. G02B 6/38

(52) U.S. Cl. CPC G02B 6/3869
USPC 385/78

(57) ABSTRACT

A plug that can be produced without performing complicated axial alignment. The plug is provided at one end of an optical fiber and is removably attached to a receptacle. A metallic cover is fitted in the receptacle. A ferrule is molded integrally with the metallic cover to hold the optical fiber. An optical element module includes a photoelectric conversion element to be optically coupled to the optical fiber and a substrate on which the photoelectric conversion element is mounted. The optical element module is press-fitted in a space formed by the metallic cover and the ferrule.

### CROSS REFERENCE TO RELATED APPLICATIONS

This application claims benefit of priority to Japanese Patent Application No. 2011-141861 filed Jun. 27, 2011, and to International Patent Application No. PCT/JP2012/062364 filed May 15, 2012, the entire content of each of which is incorporated herein by reference.

### TECHNICAL FIELD

The present technical field relates to a plug, and more particularly, to a plug provided at one end of an optical fiber.

### BACKGROUND

As a conventional plug, for example, an optical transmission module described in Japanese Unexamined Patent Application Publication No. 2010-286778 is known. FIG. 9 is a transparent view of an optical transmission module 500 described in Japanese Unexamined Patent Application Publication No. 2010-286778.

As illustrated in FIG. 9, the optical transmission module 500 roughly includes an optical fiber 502, an optical element 504, transparent resin 506, an optical element substrate 508, and a motherboard 510. The optical element 504 is mounted on the optical element substrate 508. The optical element substrate 508 is mounted on the motherboard 510. The optical fiber 502 and the optical element 504 are optically coupled to each other. The transparent resin 506 seals one end of the optical fiber 502 and a periphery of the optical element 504.

The optical transmission module 500 having the above-described structure is assembled in the following procedure. First, the optical fiber 502 and the optical element 504 are placed on a mount base, a picture of a core of the optical fiber 502 and the optical element 504 is taken with a camera from a direction of a lateral surface of the optical fiber 502, and the picture is displayed on a display. Then, the optical axes of the optical fiber 502 and the optical element 504 are aligned (axial alignment) by moving at least one of the optical fiber 502 and the optical element 504 while viewing the picture. Thus, axial alignment is performed in the direction of the lateral surface of the optical fiber 502. Similarly, a picture of the core of the optical fiber 502 and the optical element 504 is taken from a direction of an upper surface of the optical fiber 502, and axial alignment in the direction of the upper surface of the optical fiber 502 is performed. After axial alignment, the optical fiber 502 and the optical element 504 are sealed with the transparent resin 506.

In the optical transmission module 500 described in Japanese Unexamined Patent Application Publication No. 2010-286778, there is a need to perform axial alignment while observing the optical fiber 502 and the optical element 504 with the camera, as described above. For this reason, it takes a long time to produce the optical transmission module 500.

### SUMMARY

### Technical Problem

Accordingly, it is an object of the present disclosure to provide a plug that can be produced without performing a complicated axial alignment.

### Solution to Problem

A plug according to an embodiment of the present disclosure is provided at one end of an optical fiber, and is removably attached to a receptacle. The plug includes a metallic cover to be fitted in the receptacle, a resin ferrule molded integrally with the metallic cover to hold the optical fiber, and an optical element module including an optical element to be optically coupled to the optical fiber and a substrate on which the optical element is mounted. The optical element module is press-fitted in a space formed by the metallic cover and the resin ferrule.

### Advantageous Effects of the Disclosure

According to the present disclosure, production can be achieved without performing a complicated axial alignment.

### BRIEF DESCRIPTION OF DRAWINGS

FIG. 1 is an external perspective view of a connector relating to an embodiment of the present disclosure.

FIG. 2 is an external perspective view of the connector from which a plug is separated.

FIG. 3 is an external perspective view of the plug.

FIG. 4 is an exploded perspective view of the plug.

FIG. 5 is an external perspective view of an optical element module and a ferrule.

FIG. 6 is an external perspective view of the optical element module.

FIG. 7 illustrates a manner in which a main body and an electric circuit unit are mounted on a circuit board.

FIG. 8 is an exploded perspective view of a receptacle.

FIG. 9 is a transparent view of an optical transmission module described in Japanese Unexamined Patent Application Publication No. 2010-286778.

### DETAILED DESCRIPTION

A plug according to an embodiment of the present disclosure will be described below with reference to the drawings.

### [Schematic Configuration of Connector]

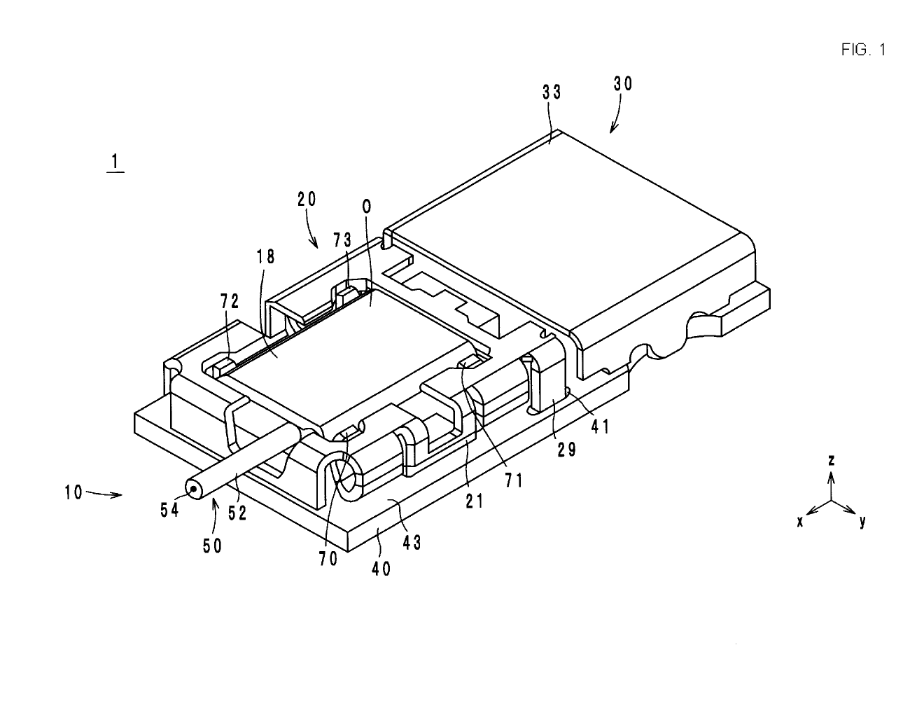

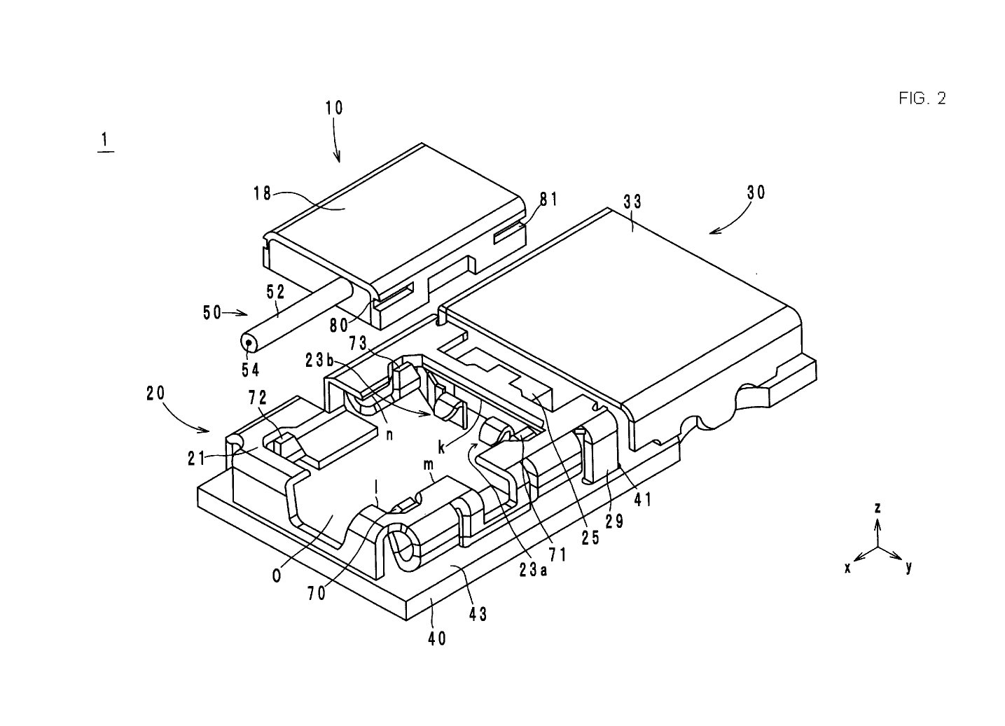

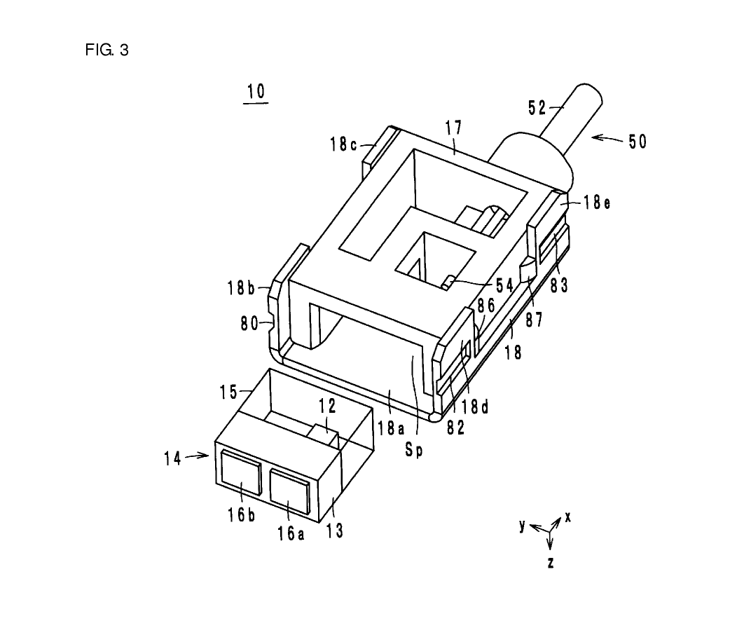

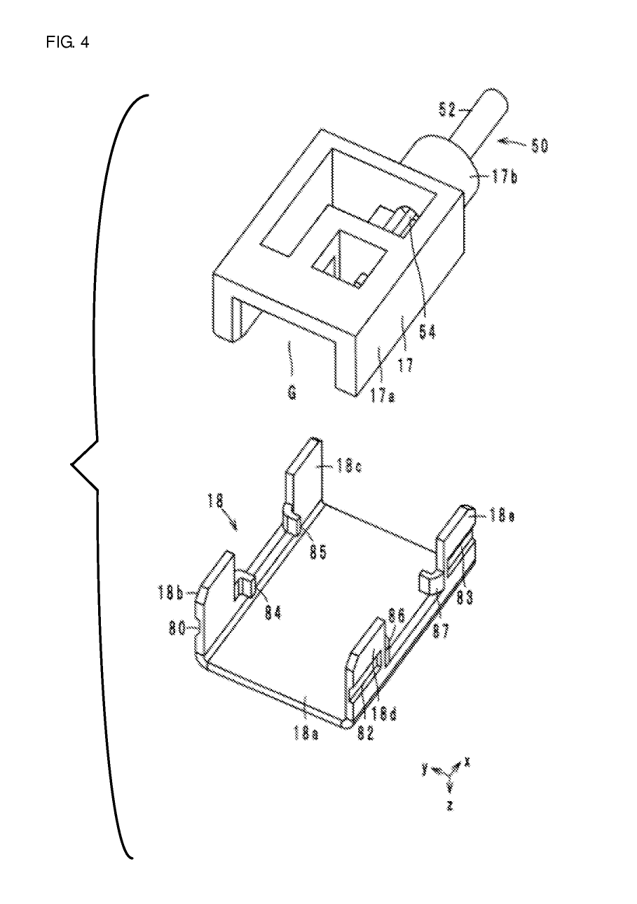

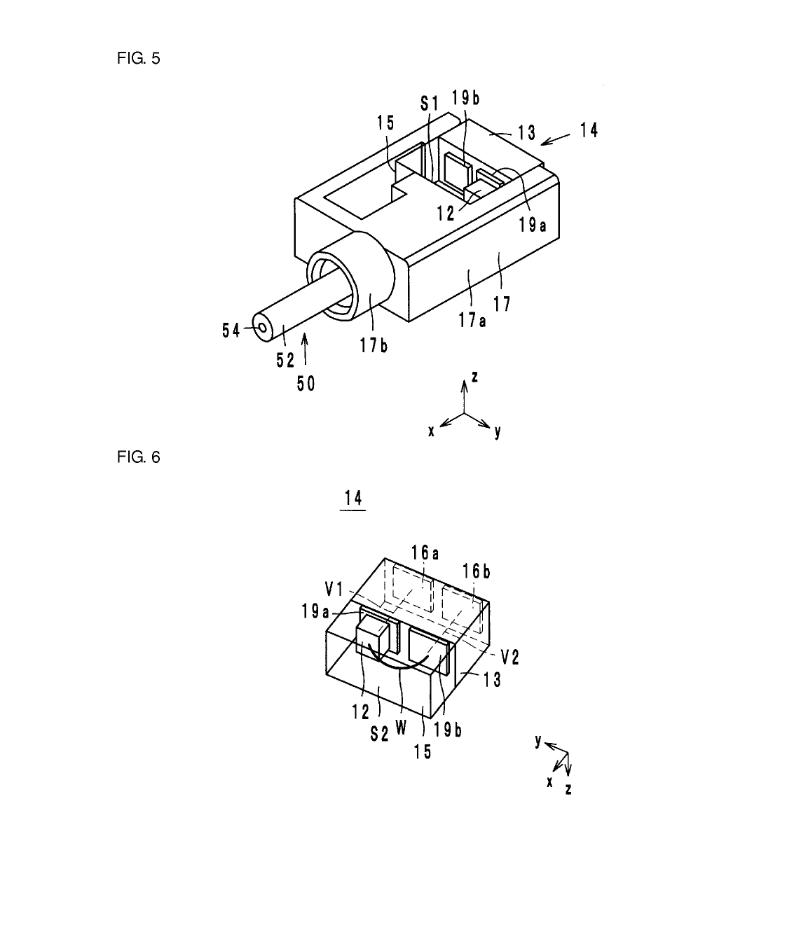

First, a schematic configuration of a connector including a plug according to an embodiment of the present disclosure will be described. FIG. 1 is an external perspective view of a connector 1 relating to the embodiment of the present disclosure. FIG. 2 is an external perspective view of the connector 1 from which a plug 10 is separated. FIG. 3 is an external perspective view of the plug 10. FIG. 4 is an exploded perspective view of the plug 10. FIG. 5 is an external perspective view of an optical element module 14 and a ferrule 17. FIG. 6 is an external perspective view of the optical element module 14.

As illustrated in FIGS. 1 and 2, the connector 1 includes a plug 10, a receptacle 20, an electric circuit unit 30, and a circuit board 40. The plug 10 is provided at one end of an optical fiber 50, and converts an optical signal into an electric signal or converts an electric signal into an optical signal. Hereinafter, a direction in which the optical fiber 50 extends is defined as an x-axis direction, an up-down direction is defined as a z-axis direction, and a direction orthogonal to the x-axis direction and the z-axis direction is defined as a y-axis direction. The x-axis direction, the y-axis direction, and the z-axis direction are orthogonal to one another.

The circuit board 40 includes electric circuits on a surface and in an inner portion thereof, and has a mount surface 43 parallel to an x-y plane, as illustrated in FIGS. 1 and 2. The mount surface 43 of the circuit board 40 has holes 41. The holes 41 are provided near a +y-axis direction side and near a −y-axis direction side of the mount surface 43 such as to be opposed to each other. On the circuit board 40, the receptacle 20 and the electric circuit unit 30 are mounted to be arranged in this order from a +x-axis direction side toward a −x-axis direction side.

The optical fiber 50 includes a jacket 52 and a core wire 54. The core wire 54 includes a core and a cladding formed of glass or resin. The jacket 52 is formed of any of UV curable resin, fluororesin, and silicone resin, and covers the core wire 54. In a −x-axis direction, end portion of the optical fiber 50 has the jacket 52 removed and the core wire 54 is exposed, as illustrated in FIG. 3.

The plug 10 is removably attached to the receptacle 20, and includes an optical element module 14, a ferrule 17, and a metallic cover 18, as illustrated in FIG. 3.

The metallic cover 18 is formed by bending a single metal sheet (for example, phosphor bronze) in an angular U-shape. The metallic cover 18 forms a +z-axis direction side surface and both y-axis direction side surfaces of the plug 10, and is to be fitted in the receptacle 20.

As illustrated in FIGS. 3 and 4, the metallic cover 18 includes an upper surface 18a and side surfaces 18b to 18e. The upper surface 18a is perpendicular to the z-axis, and has a rectangular shape. The side surfaces 18b and 18c are formed by bending the metallic cover 18 in the −z-axis direction from a +y-axis direction long side of the upper surface 18a. The side surface 18b is located closer to the −x-axis direction side than the side surface 18c. The side surfaces 18d and 18e are formed by bending the metallic cover 18 in the −z-axis direction from a −y-axis direction long side of the upper surface 18a. The side surface 18d is located closer to the −x-axis direction side than the side surface 18e.

As illustrated in FIGS. 2 to 4, the metallic cover 18 has depressed portions 80 to 83. As illustrated in FIG. 2, the depressed portions 80 to 83 are formed by recessing the side surfaces 18b to 18e, respectively.

As illustrated in FIG. 4, the side surfaces 18b to 18e have buried portions 84 to 87, respectively. As illustrated in FIG. 3, the buried portions 84 to 87 are buried in the ferrule 17. The buried portions 84 and 85 are formed by bending the side surfaces 18b and 18c, respectively, in the −y-axis direction. The buried portions 86 and 87 are formed by bending the side surfaces 18d and 18e, respectively, in the +y-axis direction.

The ferrule 17 is a resin member molded integrally with the metallic cover 18, and holds the optical fiber 50. Specifically, as illustrated in FIGS. 4 and 5, the ferrule 17 includes a body portion 17a and a cylindrical portion 17b.

The body portion 17a is shaped like a substantially rectangular parallelepiped. A depressed portion G is formed by recessing a −x-axis direction side surface of the body portion 17a in the +x-axis direction. As illustrated in FIG. 5, a bottom portion of the depressed portion G in the x-axis direction forms a positioning surface S1 perpendicular to the x-axis. The metallic cover 18 covers a +z-axis direction side surface of the body portion 17a and both y-axis direction side surfaces of the body portion 17a.

The cylindrical portion 17b protrudes from a +x-axis direction side surface of the body portion 17a in the +x-axis direction. In the body portion 17a and the cylindrical portion 17b, holes extend in the x-axis direction. The optical fiber 50 is inserted in the cylindrical portion 17b of the ferrule 17 from the +x-axis direction side. A distal end of the core wire 54 of the optical fiber 50 passes through the holes of the body portion 17a and the cylindrical portion 17b, and is located near the depressed portion G.

When the ferrule 17 is molded integrally with the metallic cover 18, a space Sp surrounded by the ferrule 17 and the metallic cover 18 is formed. More specifically, the +z-axis direction side of the depressed portion G of the ferrule 17 is covered with the upper surface 18a of the metallic cover 18, so that the space Sp forms a space shaped like a rectangular parallelepiped and having an opening on the −x-axis direction side, as illustrated in FIG. 3.

As illustrated in FIG. 6, the optical element module 14 includes a photoelectric conversion element 12, a substrate 13, sealing resin 15, external terminals 16a and 16b, terminal portions 19a and 19b, and vias V1 and V2.

The photoelectric conversion element 12 is a semiconductor element such as a photodiode or a VCSEL, and is optically coupled to the optical fiber 50. The substrate 13 is a resin substrate shaped like a rectangular parallelepiped. As will be described below, the photoelectric conversion element 12 is mounted on a +x-axis direction side surface of the substrate 13.

The external terminals 16a and 16b are provided on a −x-axis direction side surface of the substrate 13 to be arranged in this order from the +y-axis direction side toward the −y-axis direction side. The terminal portions 19a and 19b are provided on the +x-axis direction side surface of the substrate 13 to be arranged in this order from the +y-axis direction side toward the −y-axis direction side. Here, the external terminal 16a and the terminal portion 19a are opposed and connected to each other by the via V1. The external terminal 16b and the terminal portion 19b are opposed and connected to each other by the via V2. On the terminal portion 19a, the photoelectric conversion element 12 is mounted. Further, the terminal portion 19b and the photoelectric conversion element 12 are electrically connected by wire bonding using a wire W.

The sealing resin 15 is formed of transparent resin (for example, transparent epoxy resin), and seals the photoelectric conversion element 12 mounted on the substrate 13.

When the optical element module 14 is produced, a plurality of photoelectric conversion elements 12 are arranged in a matrix and mounted on a motherboard composed of a plurality of connected substrates 13. Then, a sealing resin 15 is formed by applying transparent resin on the motherboard. A mother module is thereby formed. After that, the mother module is cut into individual optical element modules 14, for example, with a dicer. Hence, each of the optical element module 14 is shaped like a rectangular parallelepiped. Hereinafter, a +x-axis direction side surface of the optical element module 14 is referred to as a contact surface S2.

As illustrated in FIG. 3, the optical element module 14 having the above-described structure is press-fitted in the space Sp of the ferrule 17 from the −x-axis direction side. That is, both y-axis direction side surfaces and both z-axis direction side surfaces of the optical element module 14 are held by the ferrule 17 and the metallic cover 18. This positions the optical element module 14 in the y-axis direction and the z-axis direction.

Further, the contact surface S2 on the +x-axis direction side of the optical element module 14 contacts with the positioning surface S1 of the depressed portion G of the ferrule 17. This positions the optical element module 14 in the x-axis direction. As a result, the optical element module 14 is positioned at a predetermined position in the depressed portion G of the ferrule 17, and the photoelectric conversion element 12 in the optical element module 14 is optically coupled to the core wire 54 of the optical fiber 50.

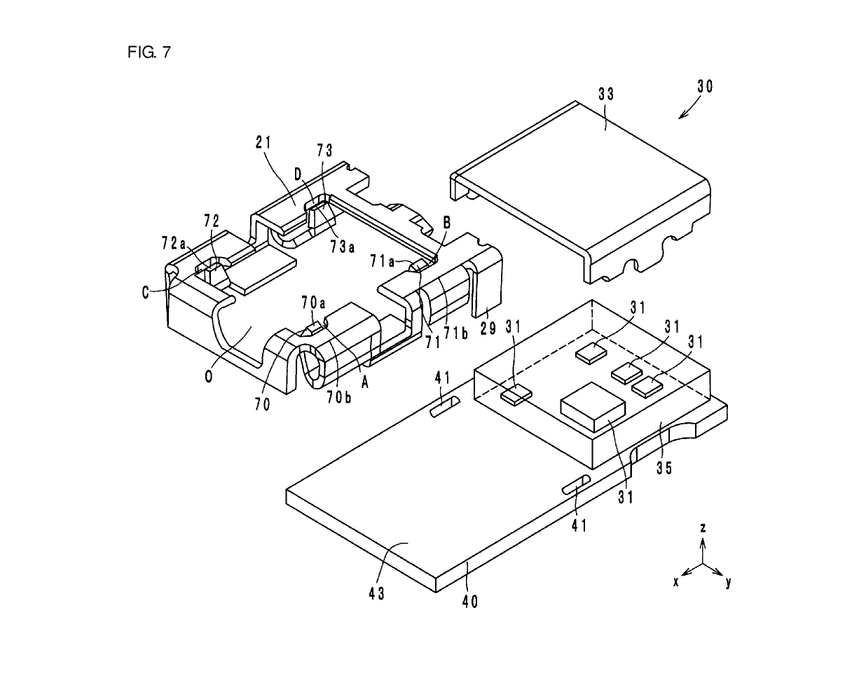

FIG. 7 illustrates a manner in which a main body 21 and the electric circuit unit 30 are mounted on the circuit board 40. As illustrated in FIG. 7, the electric circuit unit 30 is mounted on the mount surface 43 of the circuit board 40 on a −x-axis direction side of the main body 21 of the receptacle 20, and processes signals transmitted through the plug 10. The electric circuit unit 30 includes circuit elements 31, a metal cap 33, and a resin portion 35. The circuit elements 31 are electronic chip components mounted on the mount surface 43 of the circuit board 40, and drive the photoelectric conversion element 12. As illustrated in FIG. 7, the circuit elements 31 are sealed with the resin portion 35. The metal cap 33 covers the circuit elements 31 sealed with the resin portion 35. The metal cap 33 covers the resin portion 35 from the +z-axis direction side, the +y-axis direction side, and the −y-axis direction side. Next, a structure of the receptacle 20 will be described.

### [Structure of Receptacle]

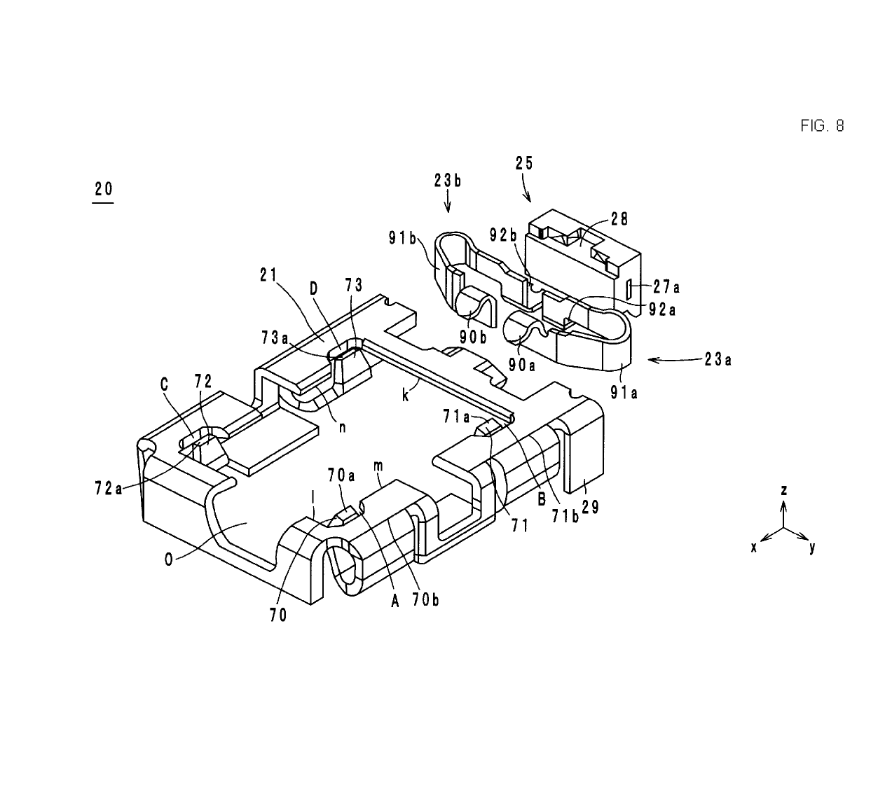

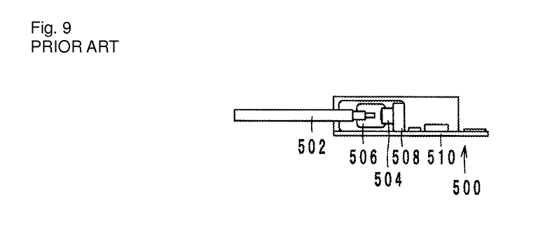

FIG. 8 is an exploded perspective view of the receptacle 20. As illustrated in FIG. 8, the receptacle 20 includes a main body 21, spring terminals 23a and 23b, an insulating portion 25, fixing members 29, and holding members 70 to 73, and is mounted on the circuit board 40. To the receptacle 20, the plug 10 is attached from the +z-axis direction side (upper side). The main body 21, the fixing members 29, and the holding members 70 to 73 are formed by bending one metal plate.

The main body 21 is a housing to which the plug 10 is attached. The main body 21 has an opening O which is rectangular when viewed from the +z-axis direction side and in which the plug 10 is attached from the +z-axis direction side. The main body 21 has a shape surrounding the plug 10 (that is, an open-square shape). More specifically, the opening O is surrounded by sides k, l, m, and n. Of the sides at the opening O extending in the y-axis direction, a −x-axis direction side is the side k, and a +x-axis direction side is the side l. Further, of the sides extending in the x-axis direction, a +y-axis direction side is the side m, and a −y-axis direction side is the side n. The side k and the side l are parallel to each other, and the side m and the side n are parallel to each other.

The main body 21 is formed by bending one open-square metal plate. More specifically, the main body 21 is formed by bending the metal plate in the −z-axis direction along a +x-axis direction side, a center portion of a +y-axis direction side, and a center portion of a −y-axis direction side.

As illustrated in FIG. 8, cutouts A and B are provided at opposite ends of the side m of the main body 21 such as to extend from the opening O in the +y-axis direction (outward direction). The cutout A is located closer to the +x-axis direction side than the cutout B. The cutouts A and B are each shaped like a trapezoid whose width in the x-axis direction decreases with increasing distance from the side m in the +y-axis direction. Cutouts C and D are provided at opposite ends of the side n of the main body 21 such as to extend from the opening O in the −y-axis direction. The cutout C is located closer to the +x-axis direction side than the cutout D. The cutouts C and D are each shaped like a trapezoid whose width in the x-axis direction decreases with increasing distance from the side n in the −y-axis direction.

As illustrated in FIG. 8, the fixing members 29 are connected to a −x-axis direction end portion of the main body at the +y-axis direction side and the −y-axis direction side. The fixing members 29 extend in the z-axis direction, and are press-fitted in the holes 41 of the circuit board 40, as illustrated in FIGS. 1 and 2. The receptacle 20 is thereby mounted on the circuit board 40. At this time, the fixing members 29 are connected to a ground conductor in the circuit board 40. The main body 21 is thereby kept at a ground potential.

The holding members 70 and 71 are spring members provided at opposite ends of the side m to fix the plug 10. The holding member 70 is located closer to the +x-axis direction side than the holding member 71. Here, −y-axis direction end portions of the holding members 70 and 71 are designated as end portions 70a and 71a, and +y-axis direction end portions thereof are designated as end portions 70b and 71b. The end portion 70a is located in the cutout A, and the end portion 71a is located in the cutout B. The end portions 70b and 71b are connected to the main body 21. Thus, the holding members 70 and 71 are U-shaped when viewed from the x-axis direction. The width of the end portions 70a and 71a in the x-axis direction is less than the width of the end portions 70b and 71b in the x-axis direction. That is, the holding members 70 and 71 are each shaped like a trapezoid whose width decreases toward a distal end.

The holding members 72 and 73 are spring members provided at opposite ends of the side n to fix the plug 10. The holding member 72 is located closer to the +x-axis direction side than the holding member 73. Here, +y-axis direction end portions of the holding members 72 and 73 are designated as end portions 72a and 73a, and −y-axis direction end portions thereof are designated as end portions 72b and 73b (not illustrated). The end portion 72a is located in the cutout C, and the end portion 73a is located in the cutout D. The end portions 72b and 73b are connected to the main body 21. Thus, the holding members 72 and 73 are U-shaped when viewed from the x-axis direction. The width of the end portions 72a and 73a in the x-axis direction is less than the width of the end portions 72b and 73b in the x-axis direction. That is, the holding members 72 and 73 are each shaped like a trapezoid whose width decreases toward a distal end.

The spring terminals 23a and 23b are terminals for signals to be electrically connected to the plug 10. The spring terminals 23a and 23b will be described in more detail below.

As illustrated in FIG. 8, the spring terminal 23a includes a contact portion 90a, a spring portion 91a, and a fixed portion 92a. The spring portion 91a is a leaf spring that connects the contact portion 90a and the fixed portion 92a and that is U-shaped to have a turn-back portion when viewed from the +z-axis direction side. The turn-back portion of the spring portion 91a is located on the +y-axis direction side.

As illustrated in FIG. 8, the spring terminal 23b includes a contact portion 90b, a spring portion 91b, and a fixed portion 92b. The spring portion 91b is a leaf spring that connects the contact portion 90b and the fixed portion 92b and that is U-shaped to have a turn-back portion when viewed from the +z-axis direction side. The turn-back portion of the spring portion 91b is located on the −y-axis direction side.

The contact portions 90a and 90b are end portions located on the +x-axis direction side, of the end portions of the spring terminals 23a and 23b. The contact portions 90a and 90b are connected to +x-axis direction end portions of the spring members 91a and 91b. As illustrated in FIG. 2, the contact portions 90a and 90b are located in the opening O when viewed from the +z-axis direction side. The contact portions 90a and 90b are bent in an inverted U-shape when viewed from the +y-axis direction side, and are led out toward the +x-axis direction sides of the spring portions 91a and 91b, respectively. The contact portions 90a and 90b are in contact with a −x-axis direction side surface of the plug 10. More specifically, the contact portions 90a and 90b are in contact with the external terminals 16a and 16b of the plug 10, respectively. Here, the contact portions 90a and 90b are inclined to form an angle of about 45° with the +x-axis direction end portions of the spring portions 91a and 91b, respectively.

The fixed portions 92a and 92b are end portions located on the −x-axis direction side, of the end portions of the spring terminals 23a and 23b, and extend in the −x-axis direction. The fixed portions 92a and 92b are located at positions shifted outward from the opening O more than the side k. The fixed portions 92a and 92b are connected to −x-axis direction end portions of the spring members 91a and 91b. When the receptacle 20 is mounted, the fixed portions 92a and 92b are connected to lands (not illustrated) on the circuit board 40 to function as external terminals.

The contact portions 90a and 90b of the spring terminals 23a and 23b having the above-described structure are in contact with the external terminals 16a and 16b, respectively, and the fixed portions 92a and 92b are connected to the lands of the circuit board 40, whereby the spring terminals 23a and 23b function as terminals for relaying signal transmission between the plug 10 and the circuit board 40.

The insulating portion 25 is shaped like a rectangular parallelepiped and is formed of resin. The insulating portion 25 is molded integrally with the spring terminals 23a and 23b. Thus, the spring terminals 23a and 23b are fixed to the main body 21 so as not to be electrically connected to the main body 21. More specifically, the spring portion 91a and the spring portion 91b are led out from a +y-axis direction side surface and a −y-axis direction side surface of the insulating portion 25, respectively, and the fixed portions 92a and 92b are led out from a back surface of the insulating portion 25. The insulating portion 25 is fixed to the main body 21 on an upper surface 28 thereof.

The plug 10 is fitted in the receptacle 20 having the above-described structure from the +z-axis direction side. At this time, as illustrated in FIGS. 1 and 2, the holding members 70 to 73 are engaged with the depressed portions 80 to 83, respectively. Further, the spring terminals 23a and 23b are electrically connected to the external terminals 16a and 16b, respectively. The plug 10 is pressed in the +x-axis direction by the spring terminals 23a and 23b. By these structures, the plug 10 is fixed to the receptacle 20.

### [Advantages]

The plug 10 having the above-described configuration can be produced without performing complicated axial alignment. More specifically, the ferrule 17 is molded integrally with the metallic cover 18. For this reason, the space Sp is accurately formed by the ferrule 17 and the metallic cover 18. Thus, the positional relationship between the space Sp and the hole of the ferrule 17, in which the optical fiber 50 is inserted, is unlikely to deviate. As a result, when the optical fiber 50 is inserted in the hole of the ferrule 17 and the optical element module 14 is press-fitted in the space Sp formed by the ferrule 17 and the metallic cover 18, the optical axes of the photoelectric conversion element 12 and the optical fiber 50 are aligned accurately. Hence, in the plug 10, an image of the photoelectric conversion element 12 and the optical fiber 50 is not taken with a camera, and complicated axial alignment is unnecessary.

In the plug 10, the optical element module 14 is shaped like a rectangular parallelepiped. For this reason, when the optical element module 14 is press-fitted in the space Sp, both y-axis direction side surfaces and both z-axis direction side surfaces of the optical element module 14 are entirely in contact with the ferrule 17 or the metallic cover 18. Therefore, the optical element module 14 is more accurately positioned relative to the ferrule 17.

In the plug 10, the contact surface S2 of the optical element module 14 on the +x-axis direction side is in contact with the positioning surface S1 of the depressed portion G of the ferrule 17. Thus, the optical element module 14 is accurately positioned in the x-axis direction.

### [Other Embodiments]

The plug of the present disclosure is not limited to the plug 10 of the above-described embodiment, and can be modified within the scope thereof.

A matching material may be applied to the distal end of the core wire 54 of the optical fiber 50. Optical coupling loss between the core wire 54 and the sealing resin 15 can be reduced by thus setting the refractive index of the matching material to be between the refractive index of the core wire 54 and the refractive index of the sealing resin 15.

It is preferable to apply resin in a gap of the ferrule 17. In this case, the optical fiber 50 and the ferrule 17 are bonded, and the metallic cover 18 and the ferrule 17 are bonded.

### INDUSTRIAL APPLICABILITY

The present disclosure is useful for a plug, and particularly, is superior in its capability of being produced without any complicated axial alignment.

1. A plug provided at one end of an optical fiber and removably attached to a receptacle, the plug comprising:
a metallic cover to be fitted in the receptacle;
a resin ferrule molded integrally with the metallic cover to hold the optical fiber; and
an optical element module including an optical element to be optically coupled to the optical fiber, the optical element being mounted on a substrate,
the optical element module being press-fitted in a space formed by the metallic cover and the resin ferrule for alignment of the optical element and the optical fiber.

2. The plug according to claim 1,
wherein the optical fiber is inserted in the resin ferrule from a predetermined direction,
wherein the optical element module is press-fitted in the space from a direction opposite from the predetermined direction, and
wherein the resin ferrule has a positioning surface which contacts the optical element module, the positioning surface is perpendicular to the predetermined direction.

3. The plug according to claim 1,
wherein the optical element module is shaped as a rectangular parallelepiped.

4. The plug according to claim 1,
wherein the optical element module further includes transparent resin that seals the optical element.

5. The plug according to claim 2,
wherein the optical element module is shaped as a rectangular parallelepiped.

6. The plug according to claim 2,
wherein the optical element module further includes transparent resin that seals the optical element.

7. The plug according to claim 3,
wherein the optical element module further includes transparent resin that seals the optical element.
